(19) United States
(12) Patent Application Publication
(10) Pub. No.: US 2014/0186575 A1
(43) Pub. Date: Jul. 3, 2014

(54) PROCESS AND APPARATUS FOR PRODUCING REINFORCING-FIBER STRIP SUBSTRATE HAVING CIRCULAR-ARC PART, AND LAYERED STRUCTURE, PREFORM, AND FIBER-REINFORCED RESIN COMPOSITE MATERIAL EACH COMPRISING OR PRODUCED USING THE SUBSTRATE

(71) Applicant: Toray Industries, Inc., Tokyo (JP)

(72) Inventors: Tamotsu Suzuki, Otsu-shi (JP); Tatsuya Hanawa, Otsu-shi (JP)

(73) Assignee: Toray Industries, Inc., Tokyo (JP)

(21) Appl. No.: 14/198,686

(22) Filed: Mar. 6, 2014

Related U.S. Application Data
(62) Division of application No. 13/146,234, filed on Jul. 26, 2011.

(30) Foreign Application Priority Data
Feb. 2, 2009 (JP) 2009-021324

(51) Int. Cl. B29C 53/02; B32B 5/26

(52) U.S. Cl. CPC B29C 53/02; B32B 5/26
USPC 428/113; 264/316; 425/403.1

(57) ABSTRACT

A process for producing a reinforcing-fiber strip substrate having a circular-arc part includes contacting one surface of a strip-shaped, unidirectional reinforcing-fiber substrate formed by arranging a plurality of reinforcing-fiber strands in one direction in parallel with each other with a flexible member; deforming the unidirectional reinforcing-fiber substrate into a circular-arc shape by deforming at least a part of the flexible member into a circular-arc shape in a direction extending along its contact surface with the unidirectional reinforcing-fiber substrate; and thereafter, separating the flexible member from the unidirectional reinforcing-fiber substrate having been deformed.

### TECHNICAL FIELD

This disclosure relates to a process and an apparatus for producing a reinforcing-fiber strip substrate having a circular-arc part curved along a longitudinal direction of the substrate, a layered structure formed using the reinforcing-fiber strip substrate, a preform formed using the layered structure, and a fiber-reinforced resin composite material molded using the preform.

### BACKGROUND

A fiber-reinforced resin composite material is broadly known as a material light in weight and high in strength and rigidity. In cases where a relatively long fiber-reinforced resin composite material is molded, to ensure high strength and rigidity in target directions, a configuration of a layered structure is frequently employed wherein a plurality of reinforcing-fiber strip substrates, in which the orientation directions of reinforcing fibers are set in respective predetermined directions, are stacked. Although there is a case where a layered structure having a configuration of a prepreg impregnated with a non-cured resin into reinforcing fibers is employed, in consideration of easiness for production to a target shape, usually a process is employed wherein a dry reinforcing-fiber layered structure, into which a resin has not been impregnated, is made, the reinforcing-fiber layered structure is formed into a preform having a predetermined shape, a matrix resin is impregnated into the formed preform, and the resin is cured to produce a fiber-reinforced resin composite material having a target shape.

Recently, for example, for a structural member of a body of an airplane, etc., a relatively long fiber-reinforced resin composite material light in weight and high in strength and rigidity has been required. Namely, it has been required to make a long reinforcing material or structural member for an airplane from a fiber-reinforced resin composite material aiming to realize a further light weight. Such a member for an airplane frequently has a cross-sectional shape, for example, such as L, T, I, C, or Z shape, and it is a rare case that the member is straight in the longitudinal direction, and in most cases, the member has a circular-arc part curved along the longitudinal direction at least at a part in the longitudinal direction. As a technology for making a long member of fiber-reinforced resin composite material having such a circular-arc part, for example, WO 2004/016844 discloses a process wherein a flat preform precursor formed from reinforcing fibers and having a circular-arc shape is prepared, and this is bent in the cross-sectional direction along the curved line of the circular-arc shape. In that disclosed process, it is described that the strain caused in the material is decreased as compared with the case of a material prepared by bending an assembly of straight strip-like reinforcing-fiber materials in the cross-sectional direction and by bending it in the longitudinal direction to form a circular-arc shape, and a high-quality composite material less in defect such as wrinkle and waving can be obtained. In that publication, however, it is not shown how the reinforcing-fiber strip substrate curved into a predetermined circular-arc shape is made and, further, how the reinforcing-fiber layered structure stacked with substrates is made.

On the other hand, as a circular-arc reinforcing-fiber layered structure, one is required wherein a plurality of layers each disposed with reinforcing fiber yarns in a plane form at a predetermined angle relative to an axial line extending in a circumferential direction of the circular arc are stacked so that the angles of the respective layers are changed to each other. As a process for making respective curved reinforcing-fiber substrates in such a reinforcing-fiber layered structure, although a process is known for disposing reinforcing-fiber tapes each having a small width at a condition adjacent to each other while maintaining them at a predetermined angle, to dispose the small-width reinforcing-fiber tapes while maintaining them at the predetermined angle relative to the axial line curved in a form of a circular-arc shape, it is necessary to dispose the respective small-width reinforcing-fiber tapes while gradually changing the arrangement directions of the reinforcing-fiber yarns of the small-width reinforcing-fiber tapes, and because a high-accuracy positioning control is required, the cost for apparatus becomes high and, besides, the productivity is poor.

On the other hand, as a process for making a curved reinforcing-fiber substrate in which the arrangement directions of the reinforcing-fiber yarns are set at predetermined directions, a process disclosed in JP-A-2004-218133 is known. In that process, the reinforcing-fiber yarns are fixed by pins, and the arrangement directions of the reinforcing-fiber yarns are curved by changing the mutual positions of the pins. In that process, however, because the tangent lines connecting surfaces of the pins become directions of the reinforcing-fiber yarns, the reinforcing-fiber yarns are disposed at a zigzag form, the adjacent reinforcing-fiber yarns strictly do not become in parallel to each other and, in addition, the fibers extend in a longitudinal form relative to a pin at a position near a turning end portion. To reduce these, required are a thin fiber bundle and a small pitch between pins, but if so, the productivity is drastically decreased. Further, that process basically relates a technology for bending a reinforcing-fiber layered structure in lump sum which is formed by stacking a plurality of reinforcing-fiber layers, different from each other in directions of reinforcing fibers of respective layers, at a multi-layer form. In the technology for bending in lump sum, since the layered structure is deformed uniformly as a whole though essentially respective proper deformation forms for respective layers, whose directions of reinforcing fibers are different from each other, are necessary, wrinkles or sags of fibers partially occur.

Paying attention to the limit in the above-described conventional technologies, it could be helpful to provide a process and an apparatus of production which can easily and securely obtain a reinforcing-fiber strip substrate having a circular-arc part in that reinforcing-fiber yarns are arranged over substantially the entire surface of a curved substrate at a desired form.

Further, it could be helpful to provide a reinforcing-fiber layered structure formed using the reinforcing-fiber strip substrate which is produced by such a process, a preform formed using the layered structure, and a fiber-reinforced resin composite material molded using the preform.

### SUMMARY

We provide a process for producing a reinforcing-fiber strip substrate having a circular-arc part characterized in that one surface of a strip-shaped, unidirectional reinforcing-fiber substrate formed by arranging a plurality of reinforcing-fiber strands in one direction in parallel with each other is brought into contact with a flexible member, the unidirectional reinforcing-fiber substrate being contacted is deformed into a circular-arc shape by deforming at least a part of the flexible member into a circular-arc shape in a direction extending along its contact surface with the unidirectional reinforcing-fiber substrate, and thereafter, the flexible member is separated from the unidirectional reinforcing-fiber substrate having been deformed.

In such a process, in particular a flexible member capable of being curved is used, and a strip-shaped, unidirectional reinforcing-fiber substrate being brought into contact with the flexible member is deformed into a circular-arc shape together with deformation to be curved of the flexible member. Since the flexible member comprising a flexible material can be deformed to be curved uniformly over the whole of the surface of a portion to be deformed to be curved, the unidirectional reinforcing-fiber substrate being contacted with the surface as a contact surface can also be deformed to be curved uniformly into a circular-arc shape over the whole of the contact surface, the respective reinforcing-fiber yarns themselves are moved to desired positions, and a reinforcing-fiber strip substrate having a circular-arc part with a desired target form can be obtained.

In the above-described process for producing a reinforcing-fiber strip substrate, a process may be employed wherein a member, formed by a plurality of elongated small pieces capable of being varied with mutual positions which are disposed adjacent to each other, is used as the above-described flexible member, and at a condition where a longitudinal direction of the small pieces and an extending direction of the reinforcing-fiber strands coincide with each other, the above-described one surface of the unidirectional reinforcing-fiber substrate is brought into contact with the flexible member. In such a configuration, because the respective small pieces can be deformed more finely and more adequately, even as the whole of the flexible member arranged with those small pieces adjacent to each other, the respective parts can be deformed more adequately, and the unidirectional reinforcing-fiber strip substrate being contacted with the flexible member can also be deformed more adequately into desired shapes at respective parts.

Further, in the above-described process for producing a reinforcing-fiber strip substrate, it is possible to employ a process wherein the unidirectional reinforcing-fiber substrate is heated at a condition where the substrate is deformed into the circular-arc shape, and thereafter, by cooling the substrate, the circular-arc shape of the substrate is fixed. Thus, by fixing the circular-arc part of the reinforcing-fiber strip substrate to a predetermined shape, even when the reinforcing-fiber strip substrates are stacked to form a layered structure, it may become possible to handle them easily while maintaining the predetermined shapes thereof.

Further, the process for producing a reinforcing-fiber strip substrate can be applied to a substrate in which reinforcing-fiber strands are arranged in various directions. In a case where a plurality of reinforcing-fiber strip substrates are stacked to form a layered structure, because usually substrates whose reinforcing-fiber strands are arranged in various directions are stacked as reinforcing-fiber layers, if the respective reinforcing-fiber substrates are curved in desired shapes and the reinforcing-fiber strands thereof are arranged in desired directions, desired shape and reinforcing fiber arrangement form can be realized as the whole of the reinforcing-fiber layered structure. For example, in a case where a unidirectional reinforcing-fiber substrate arranged with the reinforcing-fiber strands at an angle of 30 degrees or more and 90 degrees or less relative to a longitudinal direction of the substrate is used, when the above-described flexible member is deformed into the circular-arc shape, an interval between the reinforcing-fiber strands can be changed by contracting an inner-radius side of the circular-arc shape in a circumferential direction and/or expanding an outer-radius side of the circular-arc shape in a circumferential direction. In such a process, it becomes possible to realize a formation in which the reinforcing-fiber strands are adequately distributed over the entire surface of the reinforcing-fiber strip substrate to be formed into a curved shape.

In this process, for example, it is preferred to employ a manner wherein, using a unidirectional reinforcing-fiber substrate formed by connecting the reinforcing-fiber strands to each other by auxiliary yarns extending in a direction across the reinforcing-fiber strands in which a gap between the reinforcing-fiber strands satisfies the following equation, when the flexible member is deformed into the circular-arc shape, the interval between the reinforcing-fiber strands is contracted by contracting an inner-radius side of the circular-arc shape in a circumferential direction:

d/W1≧W2/r1

wherein:
W1: Width of reinforcing-fiber strand
d: Gap between reinforcing-fiber strands
r1: Inner radius of circular-arc shape
W2: Width of unidirectional reinforcing-fiber substrate.

Further, in a case where a unidirectional reinforcing-fiber substrate arranged with reinforcing-fiber strands in a longitudinal direction of the substrate in parallel with each other is used, when the flexible member is deformed into the circular-arc shape, the flexible member can be deformed so that the reinforcing-fiber strands mutually move in their longitudinal directions at a condition of parallel displacement (namely, so that the reinforcing-fiber strands mutually shift from each other in the longitudinal direction). In such a manner, it becomes possible to curve the respective reinforcing-fiber strands, extending in the longitudinal direction, into desired circular-arc shapes, and to prevent undesired local deformation or local stress from being left between the reinforcing-fiber strands.

Further, in the process for producing a reinforcing-fiber strip substrate, a process may be employed wherein, when the flexible member is deformed into the circular-arc shape, a support plate having a flat surface is disposed at a side of the unidirectional reinforcing-fiber substrate, opposite to a side disposed with the flexible member, and the unidirectional reinforcing-fiber substrate is nipped by the flexible member and the support plate. In this case, because the support plate is not deformed to be curved, when the flexible member is deformed into the circular-arc shape, a relative sliding occurs between the support plate and the unidirectional reinforcing-fiber substrate which is deformed into the circular-arc shape together with the deformation of the flexible member. Therefore, the sliding resistance is preferably to be made small so that the curved form of the unidirectional reinforcing-fiber substrate does not collapse.

As such a support plate, for example, an electrostatic attractor plate capable of attracting an object material by a static electricity can be used.

We also provide a reinforcing-fiber layered structure having a circular-arc part wherein a plurality of kinds of reinforcing-fiber strip substrates, each having a circular-arc part, whose directions of reinforcing-fiber strands are different from each other, and which are obtained by the above-described process, are layered. Since the stacked respective reinforcing-fiber strip substrates are formed as desired curved forms, respectively, also as the whole of the layered structure, a reinforcing-fiber layered structure having a desired formation can be realized wherein the reinforcing fibers of the respective reinforcing-fiber layers are adequately arranged in desired directions.

Further, we provide a preform formed by putting a reinforcing-fiber layered structure thus formed along a stereo-shaped mold having a circular-arc part in a longitudinal direction. Since the reinforcing-fiber layered structure is formed in a desired formation, the preform formed by putting it along a mold with a predetermined shape can also be easily formed in a desired formation.

Furthermore, we provide a fiber-reinforced resin composite material produced by impregnating a matrix resin into a preform thus formed and curing the matrix resin having been impregnated. Since the preform is formed in a desired formation, the fiber-reinforced resin composite material produced by impregnating a resin thereinto and curing the resin can also be easily made in a desired target formation.

An apparatus for producing a reinforcing-fiber strip substrate having a circular-arc part is characterized in that the apparatus is for deforming at least a part of a strip-shaped, unidirectional reinforcing-fiber substrate, formed by arranging a plurality of reinforcing-fiber strands in one direction in parallel with each other, into a circular-arc shape, and the apparatus comprises a flexible member having a flat contact surface with the unidirectional reinforcing-fiber substrate in which the contact surface can be bent from a straight state in a longitudinal direction into a circular-arc shape in a direction along the contact surface, a straightening means for straightening the flexible member in the longitudinal direction, and a circular-arc shape achieving means for making the flexible member in a state of the circular-arc shape.

In such an apparatus for producing a reinforcing-fiber strip substrate, the unidirectional reinforcing-fiber substrate disposed on the flexible member is deformed into a circular-arc shape together with deformation of the flexible member. The flexible member is made at a straight state in the longitudinal direction by the straightening means, it is made at a state of a target circular-arc shape by the circular-arc shape achieving means when the above-described unidirectional reinforcing-fiber substrate is curved and deformed and, after the curve deformation of the unidirectional reinforcing-fiber substrate, it is again made at a straight state in the longitudinal direction by the straightening means in preparation for the next curve deformation. Therefore, by this apparatus, it is possible to produce a plurality of curved reinforcing-fiber strip substrates in order. In a case where a different circular-arc shape is formed, the shape of the circular-arc shape achieving means may be changed. By the apparatus having such a structure, desired curved reinforcing-fiber strip substrates are produced one after another efficiently in a short period of time.

In the above-described apparatus for producing a reinforcing-fiber strip substrate, the above-described flexible member can comprise, for example, a plurality of elongated small pieces capable of being varied with mutual positions which are disposed adjacent to each other. In such a structure, as aforementioned, because the respective small pieces can be deformed more finely and more adequately, the whole of the flexible member arranged with those small pieces adjacent to each other can also be desirably deformed more adequately and, using the flexible member, a reinforcing-fiber strip substrate having a desired circular-arc part can be produced.

Further, in the above-described apparatus for producing a reinforcing-fiber strip substrate, a structure may be employed wherein the above-described contact surface of the flexible member is formed by arranging a plurality of elongated small pieces extending in a direction across a longitudinal direction of the contact surface in parallel with each other along the longitudinal direction of the contact surface, longitudinal directions of respective small pieces are set at contact surface, and respective small pieces are provided to be able to be rotated relative to each other or to be able to be rotated relative to each other and moved relative to each other in the longitudinal directions of small pieces. Such a structure is suitable for a substrate in which the arrangement directions of the reinforcing-fiber strands are set at angles of 30 degrees or more and 90 degrees or less relative to the longitudinal direction of the substrate and, in this structure, when the flexible member is made to a circular-arc state by the circular-arc shape achieving means, since the respective small pieces having been arranged at predetermined angles relative to the longitudinal direction can rotate adequately or can move relative to each other in the longitudinal directions of small pieces together with rotation, the respective small pieces can be directed in respective optimum directions under a condition where the flexible member is curved, and along the directions of the respective small pieces, the reinforcing-fiber strands located at the respective parts of the reinforcing-fiber strip substrate disposed at a position corresponding to the small pieces can also be directed in respective optimum directions. As a result, a formation can be easily realized wherein the reinforcing-fiber strands located at the respective parts of the reinforcing-fiber strip substrate formed to be curved are gradually changed with angle along the circumferential direction of the curved shape and, therefore, a desirable arrangement formation of the reinforcing-fiber strands, which has been difficult to be obtained by a conventional apparatus, can be obtained.

Further, in the above-described structure, various formations can be employed as the flexible member and the structure therearound. For example, a formation can be employed wherein the above-described flexible member comprises a deformable member capable of being recovered to a straightened shape from a shape bent into a circular-arc shape, and the above-described small pieces connected thereto. In this formation, a structure may be employed wherein the small pieces are connected to the deformable member at a condition with a constant positional relationship (at a condition where the relative positional relationship is fixed at a substantially constant positional relationship). Alternatively, a structure may also be employed wherein the small pieces are connected to the deformable member at a condition free to rotate. Furthermore, a structure may also be employed wherein a small piece pitch regulating means is provided for regulating a pitch between adjacent small pieces to a predetermined value at an appropriate position in a longitudinal direction of small piece at a state where the flexible member is bent into a circular-arc shape. The regulation of the pitch of small pieces can be performed at an arbitrary position of each small piece and, for example, it is possible to regulate the pitch at the tip side of the small piece or to regulate the pitch at an intermediate position in the longitudinal direction of each small piece.

Further, a structure may be employed wherein the contact surface of the flexible member is formed by arranging a plurality of elongated small pieces extending in a direction along a longitudinal direction of the contact surface in parallel with each other along a direction across the longitudinal direction of the contact surface, and respective small pieces are constituted to be able to be deformed into a circular-arc shape in a direction along the contact surface and are provided so that small pieces adjacent to each other can mutually move in their longitudinal directions at a condition of parallel displacement when deformed into the circular-arc shape. Such a structure is suitable for a case where the arrangement directions of the reinforcing-fiber strands are set at directions along the longitudinal direction of the substrate and, in this structure, when the flexible member is made to a circular-arc state by the circular-arc shape achieving means, since the small pieces adjacent to each other are moved relative to each other in their longitudinal directions at a condition of parallel displacement, the respective small pieces can be curved in respective optimum shapes, and along the curved shapes of the respective small pieces, the reinforcing-fiber strands located at the respective parts of the reinforcing-fiber strip substrate disposed at a position corresponding to the small pieces can also be curved in respective optimum shapes. As a result, a formation can be easily realized wherein the reinforcing-fiber strands of the reinforcing-fiber strip substrate formed to be curved are curved in desirable forms along the circumferential direction of the curved shape, respectively, and therefore, a desirable arrangement formation of the reinforcing-fiber strands of the curved substrate, which has been difficult to be obtained by a conventional apparatus, can be obtained.

Further, in the apparatus for producing a reinforcing-fiber strip substrate, a structure may be employed wherein a support plate is provided which is disposed at a side of the unidirectional reinforcing-fiber substrate, opposite to a side disposed with the flexible member, and which has a flat contact surface capable of being brought into contact with the unidirectional reinforcing-fiber substrate always during a time when the flat contact surface of the flexible member is deformed from the straight state in the longitudinal direction to a state of the circular-arc shape formed by being bent. The unidirectional reinforcing-fiber substrate to be formed to be curved is nipped between the flat contact surface of the flexible member and the flat contact surface of the support plate, and when the substrate is curved, a relative sliding is carried out between the substrate and the flat contact surface of the support plate being contacted therewith. The substrate is curved into a target circular-arc shape at a plan view while being maintained at a flat plate form, and a desired curved substrate can be easily produced. As such a support plate, for example, an electrostatic attractor plate capable of attracting an object material by a static electricity can be used.

Further, a structure may be employed wherein the above-described support plate is provided movably in directions for approaching to and retreating from the contact surface of the flexible member in a direction perpendicular to the contact surface, and movably in a direction parallel to the contact surface, and whereby, in the process for making the curved substrate and in the process for making the reinforcing-fiber layered structure stacked with the curved substrates, the support plate can be moved as needed.

In the process and the apparatus for producing a reinforcing-fiber strip substrate having a circular-arc part, by using a flexible member capable of being curved into a desired shape and curving a unidirectional reinforcing-fiber substrate together with the flexible member, a curved reinforcing-fiber strip substrate having a desirable form can be produced efficiently.

Further, in the reinforcing-fiber layered structure, by being stacked with the above-described curved reinforcing-fiber strip substrates each having a desirable form by a predetermined number, a desired form can be configured as the whole of the layered structure.

Further, in the preform, since the above-described reinforcing-fiber layered structure formed at a desired configuration is formed along a mold having a predetermined shape to make the preform, even in the formation of the preform, a desired arrangement formation of the reinforcing-fiber strands in the curved shape can be maintained.

Furthermore, in the fiber-reinforced resin composite material, since a resin is impregnated into the above-described preform formed in a desired shape and the resin is cured, the fiber-reinforced resin composite material, which is a final molded material, also becomes a composite material capable of realizing desirable properties in which reinforcing-fiber strands are arranged at a desired formation.

### BRIEF DESCRIPTION OF THE DRAWINGS

FIG. 1 is a schematic vertical sectional view of an apparatus for carrying out a process for producing a reinforcing-fiber strip substrate having a circular-arc part.

FIG. 2 is a perspective view of the apparatus depicted in FIG. 1.

FIG. 3 depicts schematic plan views showing operation states of the apparatus depicted in FIG. 1, (A) shows a state where a flexible member is straightened, and (B) shows a state where the flexible member is curved.

FIG. 4 depicts schematic plan views showing an example of configuration of a flexible member in the apparatus depicted in FIG. 1, (A) shows a state where the flexible member is straightened, and (B) shows a state where the flexible member is curved.

FIG. 5 is a partial plan view showing an example of a unidirectional reinforcing-fiber substrate.

FIG. 6 depicts partial plan views showing other examples (A), (B) and (C) of unidirectional reinforcing-fiber substrates (each example in which reinforcing-fiber strands are arranged at 90 degrees relative to a longitudinal direction of the substrate).

FIG. 7 depicts schematic plan views of flexible members in case of using substrates depicted in FIG. 6, each of (A), (C) and (E) shows a state where a flexible member is straightened, and each of (B), (D) and (F) shows a state where a flexible member is curved.

FIG. 8 depicts partial plan views showing further examples (A), (B) and (C) of unidirectional reinforcing-fiber substrates (each example in which reinforcing-fiber strands are arranged at 45 degrees relative to a longitudinal direction of the substrate).

FIG. 9 depicts schematic plan views of flexible members in case of using substrates depicted in FIG. 8, each of (A), (C) and (E) shows a state where a flexible member is straightened, and each of (B), (D) and (F) shows a state where a flexible member is curved.

FIG. 10 depicts partial plan views of flexible members showing examples (A) and (B) each where respective small pieces are connected to a deformable member at a condition free to rotate.

FIG. 11 depicts partial plan views a straightened state (A) and a curved state (B) of a flexible member having a small piece pitch regulating means.

FIG. 12 is a perspective view of a preform.

FIG. 13 is a perspective view of another preform.

FIG. 14 is a perspective view of a further preform.

FIG. 15 is a schematic perspective view of a molding apparatus showing an example of production of a fiber-reinforced resin composite material.

FIG. 16 is a schematic perspective view of a molding apparatus showing another example of production of a fiber-reinforced resin composite material.

FIG. 17 depicts schematic plan views of reinforcing-fiber sheets showing examples each where a cut line is provided on a reinforcing-fiber sheet.

### DETAILED DESCRIPTION

Hereinafter, desirable examples will be explained referring to figures.

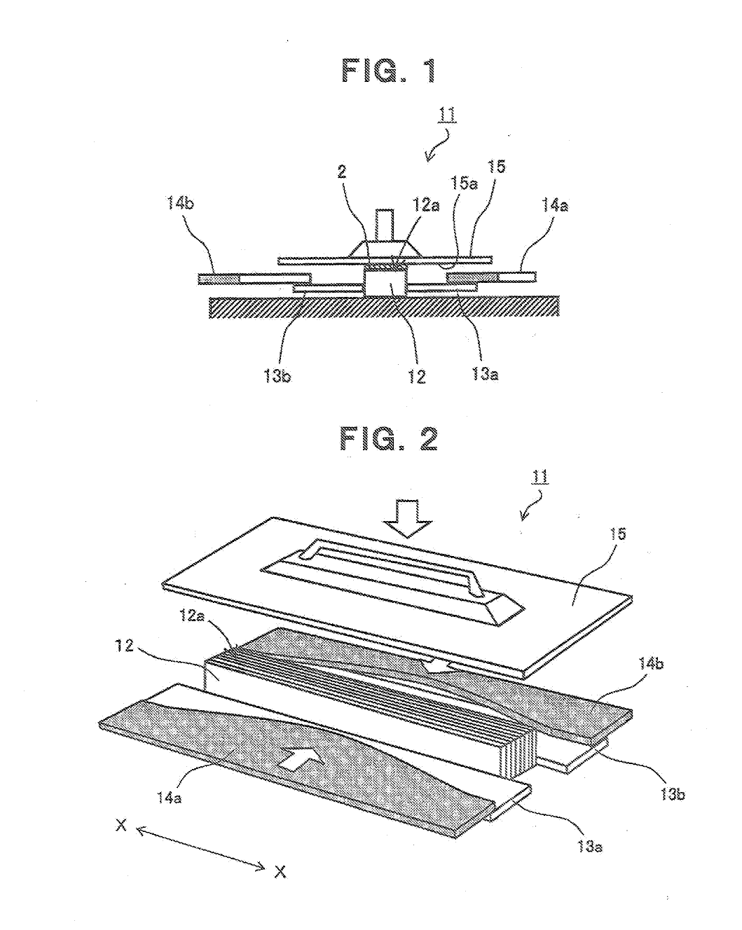

FIGS. 1 to 5 show an apparatus for carrying out a process for producing a reinforcing-fiber strip substrate having a circular-arc part together with the process for production. The apparatus shown in FIGS. 1 to 4 is exemplified as an apparatus for curving and deforming at least a part of a strip-shaped, unidirectional reinforcing-fiber substrate 2, formed by arranging reinforcing-fiber strands 1 in one direction of the longitudinal direction of substrate X-X in parallel with each other such as one shown in FIG. 5, into a circular-arc shape in a direction extending along the substrate longitudinal direction X-X (the direction of the curved shape: Y-Y). The substrate 2 shown in FIG. 5 is formed as a unidirectional reinforcing-fiber substrate 2 in which reinforcing-fiber strands 1 are connected to each other by auxiliary yarns 3 extending in a direction across the reinforcing-fiber strands 1.

In FIGS. 1 and 2, an apparatus 11 for producing a reinforcing-fiber strip substrate having a circular-arc part is an apparatus for deforming at least a part of a strip-shaped, unidirectional reinforcing-fiber substrate 2 such as one shown in FIG. 5, formed by arranging reinforcing-fiber strands 1 in one direction in parallel with each other, into a circular-arc shape, and the apparatus 11 comprises a flexible member 12 having a flat contact surface 12a with the unidirectional reinforcing-fiber substrate 2 in which the contact surface 12a can be bent from a straight state in the substrate longitudinal direction X-X into a circular-arc shape in a plane direction along the contact surface 12a, straightening means 13a, 13b for straightening this flexible member 12 in the longitudinal direction X-X, and circular-arc shape achieving means 14a, 14b for making the flexible member 12 in a curved state of the circular-arc shape. In this example, these straightening means 13a, 13b and circular-arc shape achieving means 14a, 14b are each formed from a pair of plate members facing to each other, and the pair of plate members are provided to be able to approach to and separate from each other. Further, in this example, in the apparatus 11, a support plate 15 is provided which is disposed at a side of the unidirectional reinforcing-fiber substrate 2 disposed on the flexible member 12, opposite to a side of the substrate 2 disposed with the flexible member 12, and which has a flat contact surface 15a capable of being brought into contact with the unidirectional reinforcing-fiber substrate 2 always during a time when the flat contact surface 12a of the flexible member 12 is deformed from the straight state in the longitudinal direction to a state of the circular-arc shape formed by being bent. This support plate 15 is provided movably in a vertical direction.

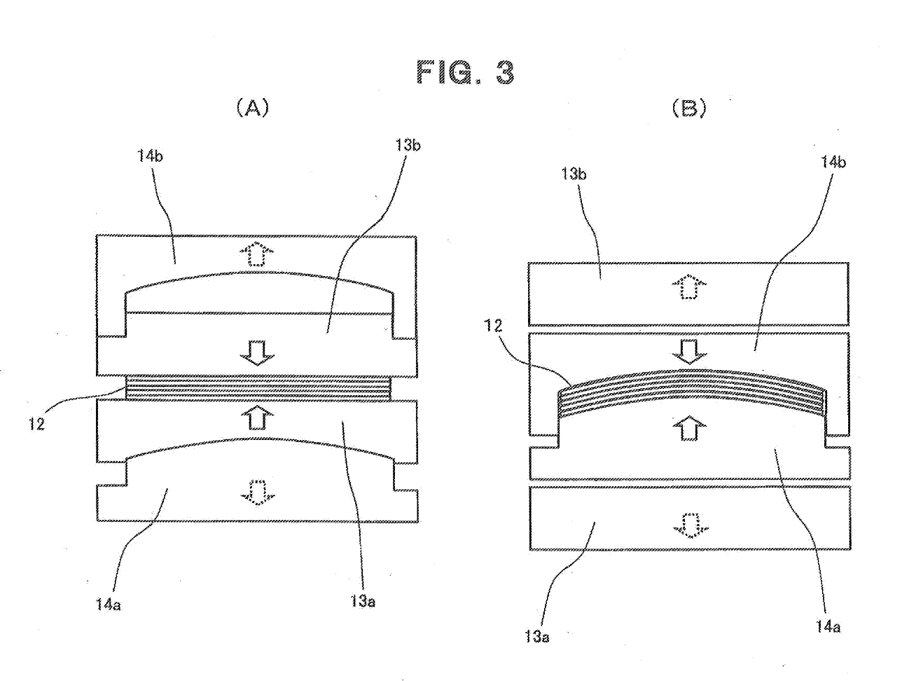

The operation of this apparatus for production will be explained referring to FIGS. 2 and 3.

As shown in FIGS. 2 and 3(A), by nipping flexible member 12 from both surface sides by straightening means 13a, 13b, the flexible member 12 is made to a straight state in the longitudinal direction X-X along the straight side edge portions of the straightening means 13a, 13b. At this state, unidirectional reinforcing-fiber substrate 2 is placed on the flexible member 12, support plate 15 is lowered, and the reinforcing-fiber substrate 2 is nipped between the flexible member 12 and the support plate 15 such that the substrate can slide relative to contact surface 15a of the support plate 15. From this state, the pair of straightening means 13a, 13b are moved in a direction being separated from each other, and circular-arc shape achieving means 14a, 14b are moved in a direction being approached to each other. Accompanying with this operation of circular-arc shape achieving means 14a, 14b, as shown in FIG. 3(B), flexible member 12 is nipped between the circular-arc shape achieving means 14a, 14b, and deformed to be curved into a circular-arc shape along the shapes of the side surfaces of the circular-arc shape achieving means 14a, 14b. Together with this flexible member 12, unidirectional reinforcing-fiber substrate 2 being contacted with the contact surface 12a thereof is also deformed to be curved into the same shape as that of the flexible member 12, and the deformation of the unidirectional reinforcing-fiber substrate 2 into a target circular-arc curved shape can be achieved. After the deformation into a predetermined curved shape, support plate 15 may be lifted up to be separated, and the curved unidirectional reinforcing-fiber substrate 2 may be taken out. If an electrostatic attractor plate capable of attracting an object material (unidirectional reinforcing-fiber substrate 2) by a static electricity is used as the support plate 15, it becomes possible to perform the contact with and the separation from the unidirectional reinforcing-fiber substrate 2 extremely easily and properly. Before or after the above-described taking out, as aforementioned, a manner may be employed wherein unidirectional reinforcing-fiber substrate 2 is heated at a condition being deformed to be curved and, thereafter, cooled to be fixed with the curved shape. Concretely, heat medium type or electric heater type heating and/or cooling means can be provided to the support plate 15. After the operation for forming the curved shape of unidirectional reinforcing-fiber substrate 2, flexible member 12 may be returned to the original straight state by the aforementioned straightening means 13a, 13b, and the above-described operation for a next substrate may be repeated.

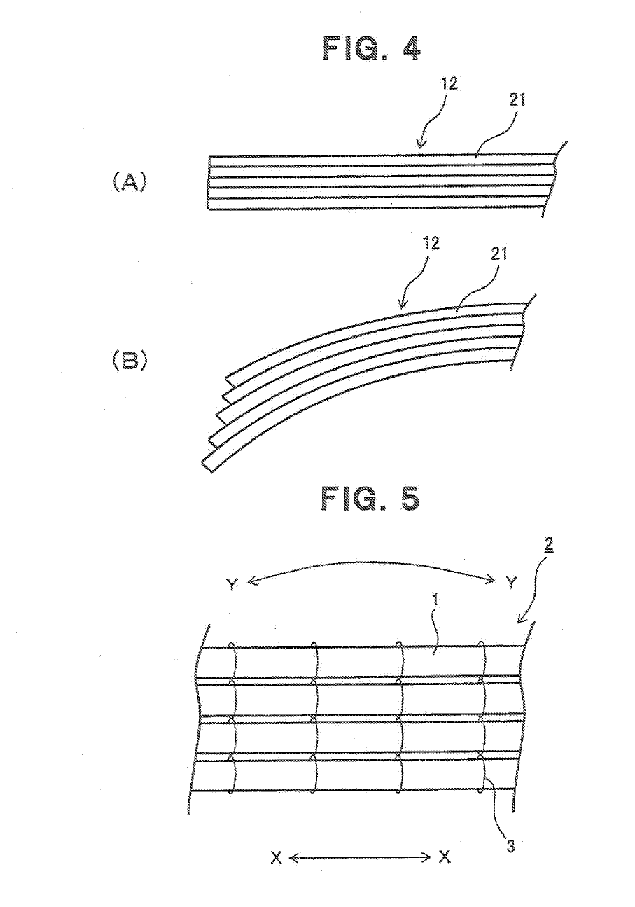

In the above-described deformation into the circular-arc shape of flexible member 12, if a configuration such as one shown in FIG. 4 is employed, for example, more smooth deformation becomes possible. Namely, to deform the flexible member so that reinforcing-fiber strands 1 of unidirectional reinforcing-fiber substrate 2 are moved relative to each other at a condition of parallel displacement, as shown in FIG. 4(A), a configuration is employed wherein the contact surface (indicated by symbol 12a in FIG. 1) of flexible member 12 is formed by arranging a plurality of elongated small pieces 21, extending in a direction along the longitudinal direction of the contact surface, in parallel to each other along a direction across the longitudinal direction of the contact surface. Then, as shown in FIG. 4(B), a configuration can be employed wherein the respective small pieces 21 structured to be able to be deformed into a circular-arc shape in a direction along the above-described contact surface, and they are provided such that, when deformed into the circular-arc shape, the adjacent small pieces 21 can move relative to each other in the longitudinal direction at a condition of parallel displacement. In such a configuration, since small pieces 21 adjacent to each other are moved in parallel with each other in the longitudinal direction when a circular-arc state is made, the respective small pieces 21 do not restrict each other in the deformation direction, and the respective small pieces 21 themselves can be curved into respective optimum shapes. Therefore, along the curved shapes of the respective small pieces 21, reinforcing-fiber strands 1 in the respective parts of reinforcing-fiber strip substrate 2, which are arranged at the positions corresponding to those of the small pieces, are also curved into respective optimum shapes, and over the whole of the curved reinforcing-fiber strip substrate 2, desirably curved reinforcing-fiber strands 1 can be distributed.

As the material of small pieces 21 shown in FIG. 4, a soft material such as a rubber or an elastomer, formed as a plate-like shape, is preferably used. Further, although unidirectional reinforcing-fiber substrate 2 shown in this example has a formation in which auxiliary yarns 3 extend continuously in a direction across reinforcing-fiber strands 1, in this case, the auxiliary yarns 3 are preferably given slack between the reinforcing-fiber strands to not prevent movement of the reinforcing-fiber strands 1 relative to each other. By such a configuration, when the unidirectional reinforcing-fiber substrate is formed in a curved shape, by the mutual movement of the reinforcing-fiber strands, the auxiliary yarns located at a position nearer the terminal end side of the circular arc are inclined more greatly relative to the longitudinal direction of the reinforcing-fiber strands, and it becomes possible that the auxiliary yarns follow this deformation. The amount of the slack between the reinforcing-fiber strands can be appropriately decided geometrically from width of reinforcing-fiber strand, radius of curvature of circular arc and length (angle) of circular-arc part.

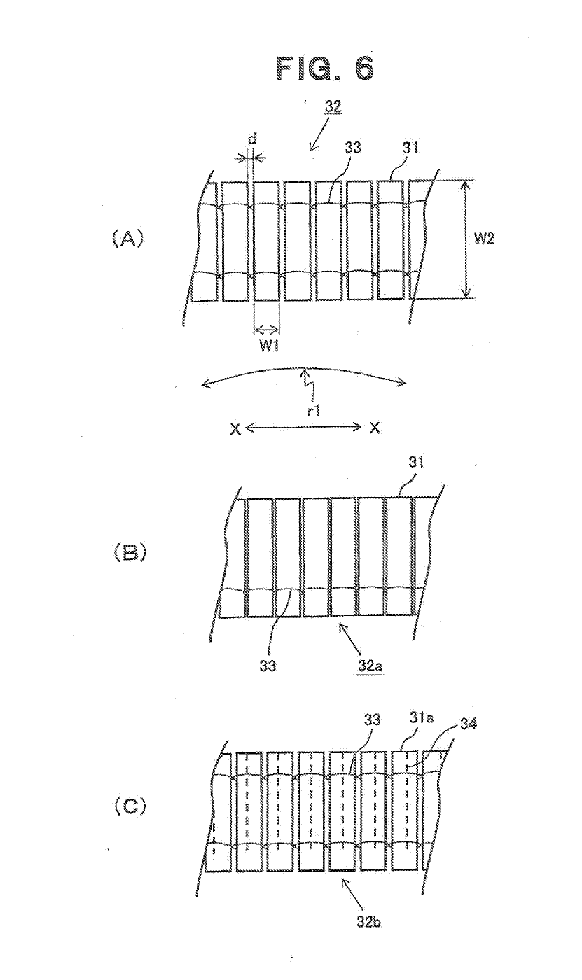

Although the above-described explanation has been carried out with respect to a case of unidirectional reinforcing-fiber strip substrate 2 in which reinforcing-fiber strands 1 are arranged in parallel to each other in one direction of the substrate longitudinal direction X-X, it can also be applied to a substrate in which the reinforcing-fiber strands are arranged in another direction, for example, the reinforcing-fiber strands are arranged at an angle of 30 degrees or more and 90 degrees or less relative to the longitudinal direction of a substrate. For example, as shown in FIG. 6(A) with a case of a unidirectional reinforcing-fiber strip substrate 32 arranging reinforcing-fiber strands 31 at an angle of 90 degrees relative to the longitudinal direction X-X of the substrate, it is possible to curve this substrate 32 at a predetermined radius of curvature along its longitudinal direction X-X together with the flexible member. Symbol 33 in FIG. 6(A) indicates an auxiliary yarn for connecting the reinforcing-fiber strands 31 to each other. Although reinforcing-fiber strands 31 are connected to each other by two auxiliary yarns 33 in the example shown in FIG. 6(A), as shown in FIG. 6(B), it is possible to form a unidirectional reinforcing-fiber strip substrate 32a by connecting reinforcing-fiber strands 31 to each other by a single auxiliary yarn 33 at any positions in the longitudinal direction of the reinforcing-fiber strands 31. In such a configuration, when the unidirectional reinforcing-fiber substrate 32a is curved in a circular-arc shape using a flexible member described below, the freedom of displacement of adjacent reinforcing-fiber strands 31 can be increased, and the operation of making the curve can be easily carried out. Further, as shown in FIG. 6(C), by using reinforcing-fiber strands 31a each having a cut line 34 extending up to an intermediate position, when a unidirectional reinforcing-fiber substrate 32b is deformed to be curved, the freedom of displacement and deformation of the reinforcing-fiber strands 31a themselves can also be increased.

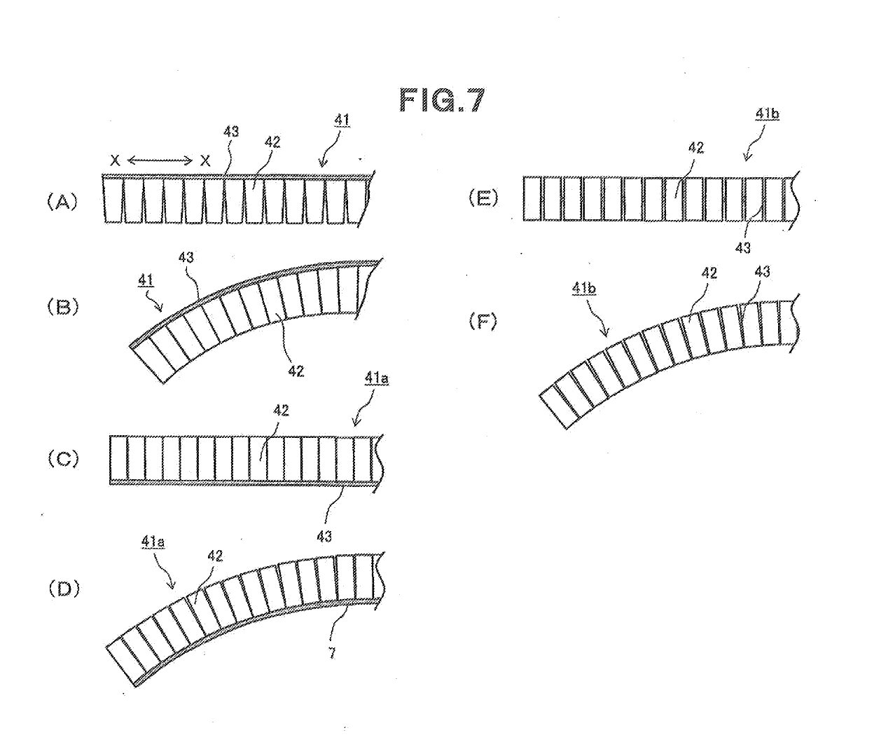

For the above described unidirectional reinforcing-fiber strip substrate arranged with the reinforcing-fiber strands at an angle of 90 degrees, for example, the following flexible member can be used. For example, as shown in FIG. 7(A), a structure can be employed wherein flexible member 41, particularly, the contact surface thereof with the substrate, is formed by arranging a plurality of elongated small pieces 42, each extending in a direction across the longitudinal direction X-X of the contact surface, along the longitudinal direction of the contact surface. Each small piece 42 can be set so that the longitudinal direction of small piece 42 has an appropriate angle, for example, in a range of 30 degrees or more and 90 degrees or less relative to the longitudinal direction X-X of the contact surface and the small piece can be rotated, depending on the objective unidirectional reinforcing-fiber substrate to be curved and, for example, for substrate 32 shown in the above-described FIG. 6(A), the longitudinal direction of small piece 42 may be set at an angle of 90 degrees relative to the longitudinal direction X-X of the contact surface. In such a configuration, as shown in FIG. 7(B), when the flexible member is deformed into a circular-arc shape, by contracting the inner-radius side of the circular-arc shape in a circumferential direction, the interval between the reinforcing-fiber strands can be changed, and it becomes to achieve a uniform distribution of the reinforcing-fiber strands. It is preferred that small pieces 42 shown in FIGS. 7 (A) and (B) comprise, for example, resin plates, because they are light in weight and they can be moved easily, and that their upper portions are connected to each other, for example, by a metal plate spring 43 which is straight at no-load condition, because it has an operation for returning the deformation of the flexible member to a straight condition and the small pieces 42 can be easily recovered to be arranged in parallel to each other.

Such a relative positional relationship between small pieces 42 and plate spring 43 connecting them can also be set to be shown in FIGS. 7 (C) and (D), and in such a flexible member 41a thus constructed, by expanding the outer-radius side of the circular-arc shape in the circumferential direction, the interval between the reinforcing-fiber strands can be changed, and it becomes to achieve a uniform distribution of the reinforcing-fiber strands. Further, as shown in FIGS. 7 (E) and (F), the respective small pieces 42 can also be connected by plate spring 43 at their intermediate portions in the longitudinal direction of the small pieces 42 (in the example shown in the figure, central portions), and in such a flexible member thus constructed, by contracting the inner-radius side of the circular-arc shape in the circumferential direction and expanding the outer-radius side of the circular-arc shape in the circumferential direction, the interval between the reinforcing-fiber strands can be changed, and it becomes to achieve a uniform distribution of the reinforcing-fiber strands.

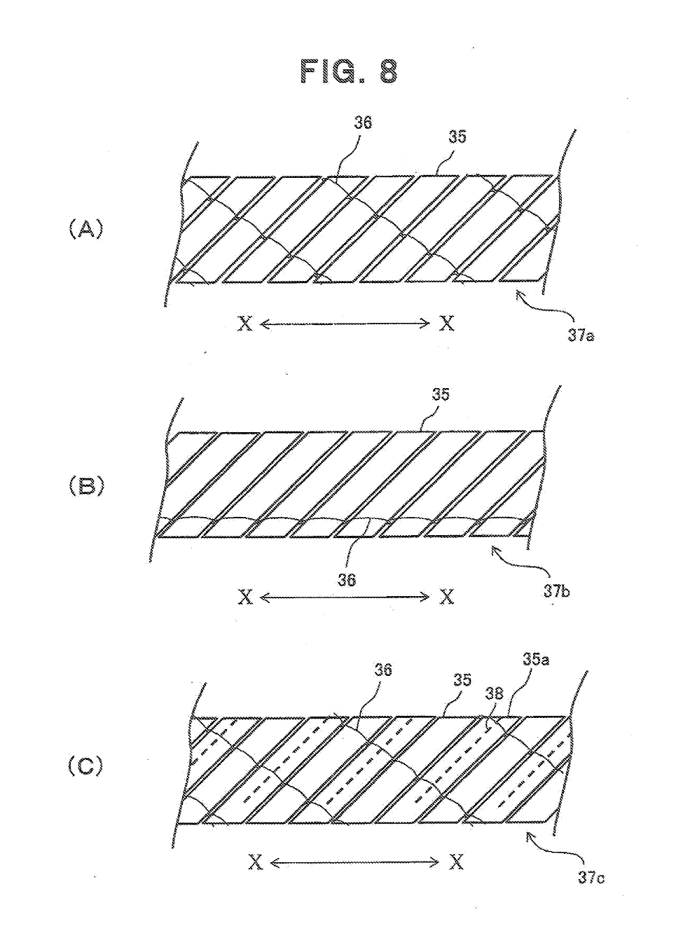

Further, other examples for cases each where the reinforcing-fiber strands are arranged at an angle in a range of 30 degrees or more and 90 degrees or less relative to the longitudinal direction of the substrate will be shown. For example, in FIG. 8(A), an example of a unidirectional reinforcing-fiber strip substrate 37a is shown which is prepared by arranging reinforcing-fiber strands 35 at an angle of 45 degrees relative to the longitudinal direction X-X of the substrate and connecting them to each other by a plurality of auxiliary yarns 36 extending in a direction across them. In FIG. 8(B), an example of a unidirectional reinforcing-fiber strip substrate 37b is shown, as compared with the example shown in FIG. 8(A), which is prepared by connecting reinforcing-fiber strands 35 to each other by a single auxiliary yarn 36 extending in the longitudinal direction X-X of the substrate. In FIG. 8(C), an example of a unidirectional reinforcing-fiber strip substrate 37c is shown, as compared with the example shown in FIG. 8(A), which is prepared by arranging reinforcing-fiber strands 35 and reinforcing-fiber strands 35a each having a cut line 38 alternately and connecting them to each other by a plurality of auxiliary yarns 36 extending in a direction across them.

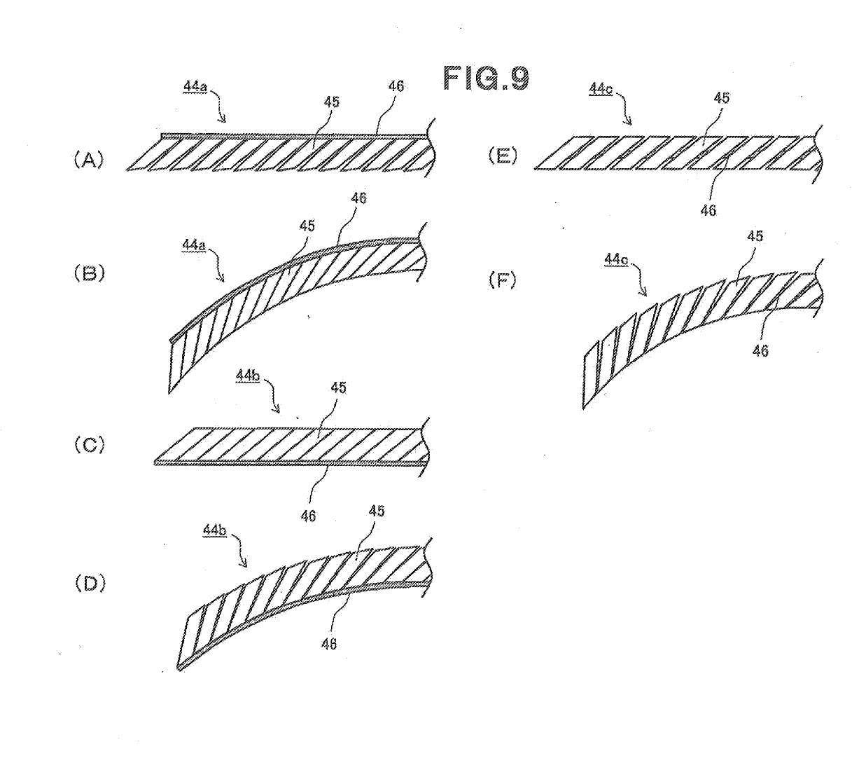

For such a unidirectional reinforcing-fiber strip substrate prepared by arranging reinforcing-fiber strands at an angle of 45 degrees relative to the longitudinal direction X-X of the substrate, to deform it to be curved, for example, a flexible member as shown in FIG. 9 can be used. The example shown in FIGS. 9 (A) and (B) has a structure corresponding to that shown in FIGS. 7 (A) and (B), the example shown in FIGS. 9 (C) and (D) has a structure corresponding to that shown in FIGS. 7 (C) and (D), and the example shown in FIGS. 9 (E) and (F) has a structure corresponding to that shown in FIGS. 7 (E) and (F). Namely, shown are flexible members 44a, 44b and 44c wherein respective small pieces 45, which are disposed at an angle of 45 degrees relative to the longitudinal direction X-X of the substrate before curving and which comprise resin plates, for example, are connected to each other by, for example, a metal plate spring 46 which extends straightly at no-load condition.

Further, in the above-described case using a unidirectional substrate in which the reinforcing-fiber strands are connected to each other by an auxiliary yarn extending in a direction across them and the reinforcing-fiber strands are arranged at an angle of 30 degrees or more and 90 degrees or less relative to the longitudinal direction of the substrate, it is preferred to provide room to the auxiliary yarn so that the gap between the reinforcing-fiber strands at a state before curving satisfies the following equation and to contract the interval between the reinforcing-fiber strands at the time of curving by contracting the inner-radius side of the circular-arc shape. In such a configuration, can be avoided problems in that the deformation of the reinforcing-fiber substrate is damaged by bridging of the auxiliary yarn caused by receiving a tension at the time of curving and in that the reinforcing-fiber strands come into contact with each other at the inner-radius side of the circular arc because of lack in gap between reinforcing-fiber strands and the deformation of contraction cannot progress, and therefore, a more uniform distribution of the reinforcing-fiber strands can be achieved, and as described later, a pretreatment such as cutting of auxiliary yarn becomes unnecessary.

d/W1≧W2/r1

The meaning of the respective signs are as follows as shown in FIG. 6(A):
W1: Width of reinforcing-fiber strand
d: Gap between reinforcing-fiber strands
r1: Inner radius of circular-arc shape
W2: Width of unidirectional reinforcing-fiber substrate.

The material of the flexible member is not particularly limited, as long as it is a material capable of being deformed into the above-described curved state, and further, being recovered into a straight state, and as aforementioned, a soft material such as a rubber or an elastomer or a hard material such as a metal or a resin can be used solely or as combination. As its shape, a plate-like or prismatic shape can be applied. As the entire shape, except the configuration having divided small pieces as shown in FIG. 4 or FIG. 7, it is also possible to form a flexible member which is formed integrally as a whole without being divided and which can be expanded and contracted both as a whole and partially.

Further, the contact surface of the flexible member with the unidirectional reinforcing-fiber substrate is preferably high in friction with the reinforcing-fiber substrate. Concretely, configurations can be employed for the contact surface such as a low-hardness rubber, a material having fine projections such as a sand paper, for example, a metal plate sprayed with a ceramic, or various materials whose surfaces are roughened mechanically. Further, in such means for increasing the coefficient of friction, it is not necessary to apply it over the entire contact surface, it may be applied to some of small pieces forming the flexible member selectively, or may be applied to a part of each small piece, and further, a method for nipping a thin wire netting, which is slightly higher than the height of the small piece, between the small pieces, is also preferred, because the reinforcing-fiber substrate can be caught effectively and a shift of the substrate at the time of curving can be prevented.

Further, as the material of reinforcing fibers, although carbon fibers, glass fibers, aramide fibers and the like can be exemplified, in particular, carbon fibers are preferred because of high mechanical properties when made finally into a fiber-reinforced resin composite material, and in a case where an electrostatic attractor plate is used as means for separating and conveying the support plate and/or the curved reinforcing-fiber substrate from the flexible member, particularly carbon fibers are preferably employed because carbon fibers have a conductivity and a high attraction force can be obtained by the static electricity.

Further, with respect to the configuration of the unidirectional reinforcing-fiber substrate as a target of deformation into a curved shape, except the substrate in which the reinforcing-fiber strands are bound by auxiliary yarns as described above, a substrate may be employed wherein the reinforcing-fiber strands are merely arranged over the whole of the substrate. Further, with the substrate using auxiliary yarns, it is also possible to facilitate its deformation into a curved shape by cutting the auxiliary yarns partially or over the whole thereof.

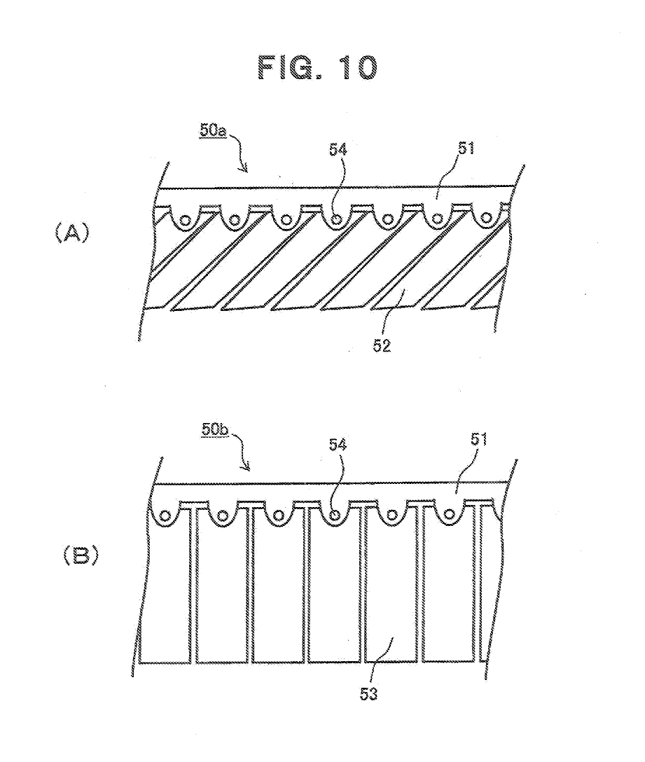

Further, as aforementioned, at an initial condition of a flexible member, a configuration can be employed wherein the respective small pieces are connected to the plate spring as a deformable member at a condition with a constant positional relationship, and a configuration can also be employed wherein the respective small pieces are connected to the deformable member at a condition free to rotate. For example, as shown in FIG. 10(A) (case where the respective small pieces are set to have an angle of 45 degrees relative to the longitudinal direction of the substrate) or FIG. 10(B) (case where the respective small pieces are set to have an angle of 90 degrees relative to the longitudinal direction of the substrate), configurations of flexible members 50a, 50b can be employed wherein respective small pieces 52, 53 are connected to the deformable member, for example, a metal plate spring 51 via respective pins 54 at a condition free to rotate. Thus, by connecting respective small pieces 52, 53 at a condition free to rotate, when the flexible members 50a, 50b are deformed into curved shapes, the respective small pieces 52, 53 can be easily rotated to a desired angle, thereby curving also the unidirectional reinforcing-fiber substrate more easily.

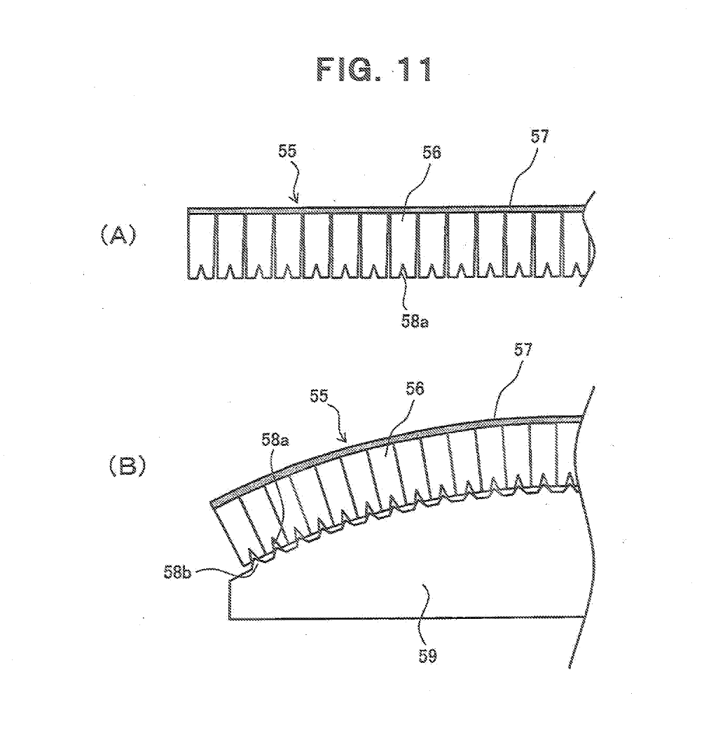

Furthermore, to curve the flexible member, in which the respective small pieces are set at an angle of 30 degrees or more and 90 degrees or less, into a predetermined shape more precisely, or to be able to maintain the curved shape to a predetermined shape as needed, a configuration can be employed wherein a small piece pitch regulating means is provided for regulating a pitch between adjacent small pieces to a predetermined value at an appropriate position in a longitudinal direction of small piece at a state where the flexible member is bent into a circular-arc shape. For example, in FIG. 11, a flexible member 55 is exemplified in which respective small pieces 56 are connected to, for example, a metal plate spring 57 as the deformable member to have an angle of 90 degrees relative to the longitudinal direction of the substrate. As shown in FIG. 11(A), recessed portions 58a (for example, V-notch like recessed portions) are provided on the tips of the respective small pieces 56, when this flexible member 55 is curved, as shown in FIG. 11(B), by performing an abutting operation and the like relative to a small piece pitch regulating means 59 having projected portions 58b disposed at a predetermined pitch and capable of being fitted into the above-described recessed portions 58a, the respective projected portions 58b and the respective recessed portions 58a corresponding thereto are fitted to each other. Since the respective projected portions 58b are disposed at a predetermined pitch decided in advance, the tip portions of the respective small pieces 56 each having recessed portion 58a are aligned at a desired pitch. At the same time, by setting of the tip surface of small piece pitch regulating means 59 having projected portions 58b at a predetermined curved shape decided in advance, the curved shape of flexible member 55 is also regulated to a desired shape. Namely, the curved shape of flexible member 55 and the pitch of the tip portions of the respective small pieces 56 are set at desired configurations at the same time. Although an example is shown in FIG. 11 wherein small piece pitch regulating means 59 is provided relative to the tip portions of the respective small pieces 56, it is possible to provide it relative to portions other than the tip portions of the respective small pieces 56. Further, such a configuration having a small piece pitch regulating means can also be applied to a case other than the case where the respective small pieces are set to have an angle of 90 degrees relative to the longitudinal direction of the substrate.

A plate-like reinforcing-fiber layered structure, wherein a plurality of curved unidirectional reinforcing-fiber strip substrates described above are stacked, is formed by repeating the operation of separating and conveying the reinforcing-fiber substrate, deformed by the aforementioned flexible member, from the flexible member, and placing it on a table for layering. This operation for separating and conveying the reinforcing-fiber substrate is efficiently carried out by the aforementioned operation of the support plate. In practice, such a reinforcing-fiber layered structure is used as a material for molding into a target fiber-reinforced composite material.

Using the above-described reinforcing-fiber layered structure, a preform having a predetermined configuration is formed. As the shape of the preform, although an arbitrary shape utilizing the above-described curved shape can be employed, in case where long size and high strength and rigidity are required such as a case for a structural member for a body of an airplane, formed is a shape having a flange portion as its cross-sectional shape.

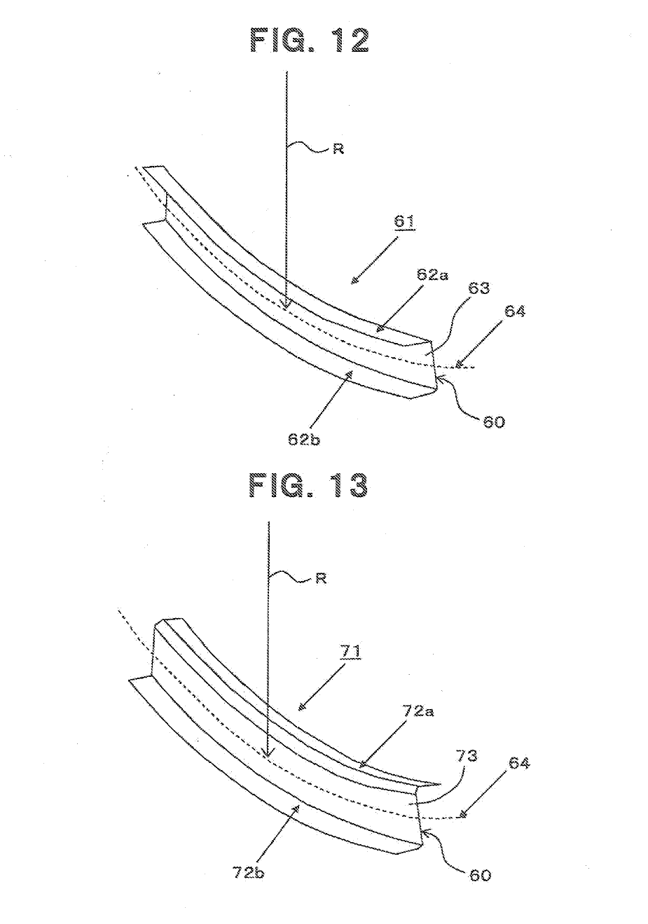

For example, as shown in FIG. 12, using a reinforcing-fiber layered structure 60 such as one described above, a preform 61 curving at a radius of curvature R and extending in the circumferential direction 64 (the longitudinal direction) of the layered structure is formed along a stereo-shaped mold (not shown) having a circular-arc part in the same direction. However, with respect to forming process itself and the mold used for the forming, arbitrary and appropriate process and mold can be used. In such a preform 61, the curved reinforcing-fiber layered structure 60 made as described above is formed in a shape having flange portions 62a, 62b formed by bending the structure along the circumferential edge of the curved shape (namely, along the circumferential direction 64 of the curved shape having a radius of curvature R) as viewed in the cross section of the width direction of the layered structure perpendicular to the longitudinal direction of the layered structure 60. Both flange portions 62a, 62b are formed to be bent in the same direction, and the preform 61 has a C-shaped cross section. The bent angles of flange portions 62a, 62b relative to a web portion 63 may be other than 90 degrees, and the bent angles of flange portions 62a, 62b relative to the web portion 63 may be different from each other. Further, the sizes of flange portions 62a, 62b may also be same or may be different from each other. This preform 61 is a dry preform as an intermediate formed material for molding a fiber-reinforced composite material having a predetermined long-sized curved shape.

A preform 71 shown in FIG. 13 is formed in a shape having flange portions 72a, 72b formed to be curved along the circumferential direction 64 of the curved shape having a radius of curvature R relative to the curved reinforcing-fiber layered structure 60 made as aforementioned. In this example, both flange portions 72a, 72b are formed to be bent in directions opposite to each other relative to a web portion 73, and the preform 71 has a Z-shaped cross section. Other than the cross-sectional shapes shown in FIGS. 12 and 13, for example, forming into L-shaped, H-shaped, I-shaped, or T-shaped cross section is possible.

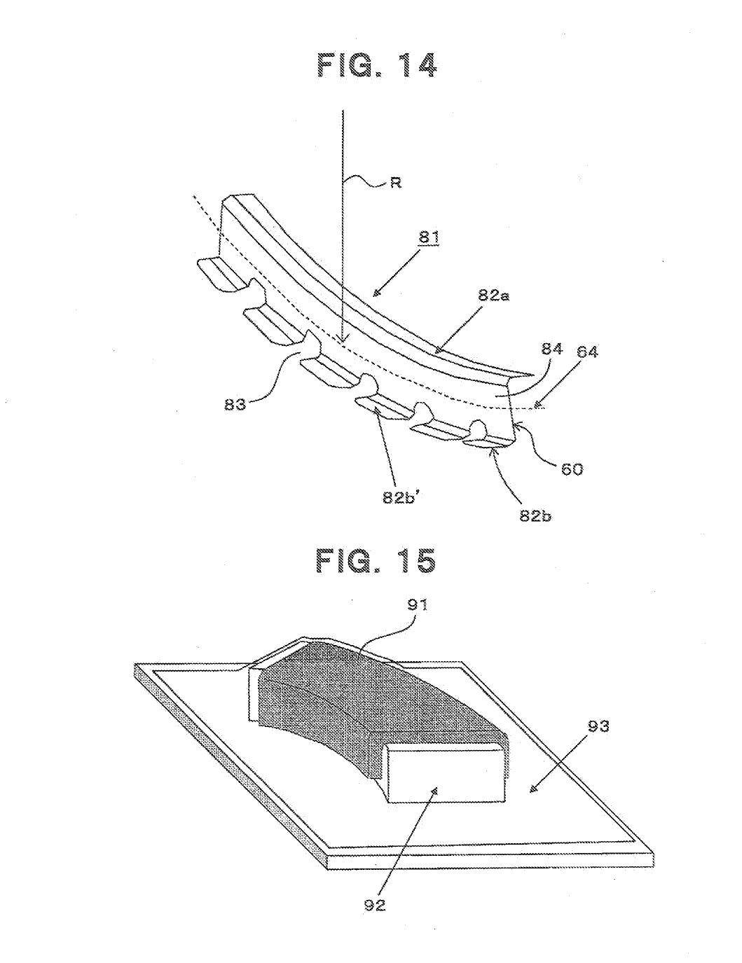

A preform 81 shown in FIG. 14 is formed in a shape having flange portions 82a, 82b formed to be curved along the circumferential direction 64 of the curved shape having a radius of curvature R relative to the curved reinforcing-fiber layered structure 60 made as aforementioned. In this example, both flange portions 82a, 82b are formed to be bent in directions opposite to each other relative to a web portion 84, and the preform 81 has a Z-shaped cross section. Further, in this example, among both flange portions 82a, 82b, the flange portion 82b, which is bent along a circumferential edge of the curved shape at a side having a greater radius of curvature of the curved shape, is divided into a plurality of flange portions 82b′ in the longitudinal direction of the layered structure 60, and a space 83 is defined between adjacent divided flange portions 82b′. As shown in the figure, it is preferred that the space 83 extends up to web portion 84 by an appropriate length. Thus, by forming the flange portion 82b at a side having a greater radius of curvature into the shape having space 83 between divided flange portions 82b′, it becomes possible to prevent a stress from leaving and wrinkles from occurring at the time of bending.

Using a dry preform formed in a predetermined cross sectional shape as described above, a fiber-reinforced resin composite material having a desired shape is molded by impregnation a matrix resin into the preform and curing the impregnated resin. In this case, a process can also be employed wherein, at the state where the flange portions of the preform are formed, the formed shape of the preform is fixed by heating for a predetermined time, and thereafter, the resin is impregnated. By fixing the formed shape of the preform by heating, the configuration is prevented from being collapsed even at the time of resin impregnation. The molding of a curved fiber-reinforced resin composite material can be carried out, for example, by RTM process (Resin Transfer Molding), and a matrix resin (for example, a thermosetting resin such as an epoxy resin) is impregnated into the preform, the impregnated resin is cured by heating to a predetermined temperature, and a fiber-reinforced resin composite material having a desired shape is produced.

As the process for producing a fiber-reinforced resin composite material having a curved shape, various processes can be employed. For example, a process using a bag material, a process using a double-sided mold or the like can be employed. FIG. 15 shows an example of a process using a bag material (so called “Vacuum-assisted RTM”). A preform 91 formed in a predetermined cross-sectional shape is placed on a mold 92, and the preform 91 is covered with a sheet-like bag material 93 and the inside is closed and sealed. The closed and sealed inside is reduced in pressure by evacuation, a matrix resin is injected into the inside reduced in pressure, and the injected resin is impregnated into the preform 91. The impregnated resin is cured, for example, by heating. In such a molding process, since a material having a predetermined area may be used as bag material 93 as long as the mold 92 as a lower mold is made at a high accuracy, a large-sized curved fiber-reinforced resin composite material can be molded extremely easily.

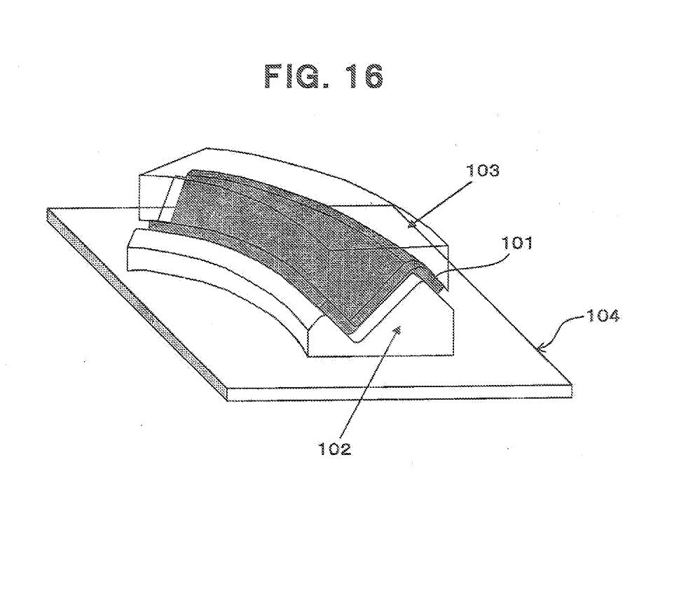

Further, in the molding process shown in FIG. 16, a preform 101 formed into a predetermined cross-sectional shape as aforementioned is placed in a mold 104 comprising a double-sided mold of a lower mold 102 and an upper mold 103, a matrix resin is injected into the mold 104 (any of evacuation-type injection and pressurizing-type injection may be employed), the injected resin is impregnated into the preform, and the impregnated resin is cured, for example, by heating. In such a molding process, because the shape of a fiber-reinforced resin composite material to be molded is defined from both surfaces, it is possible to mold a curved fiber-reinforced resin composite material at a higher accuracy.

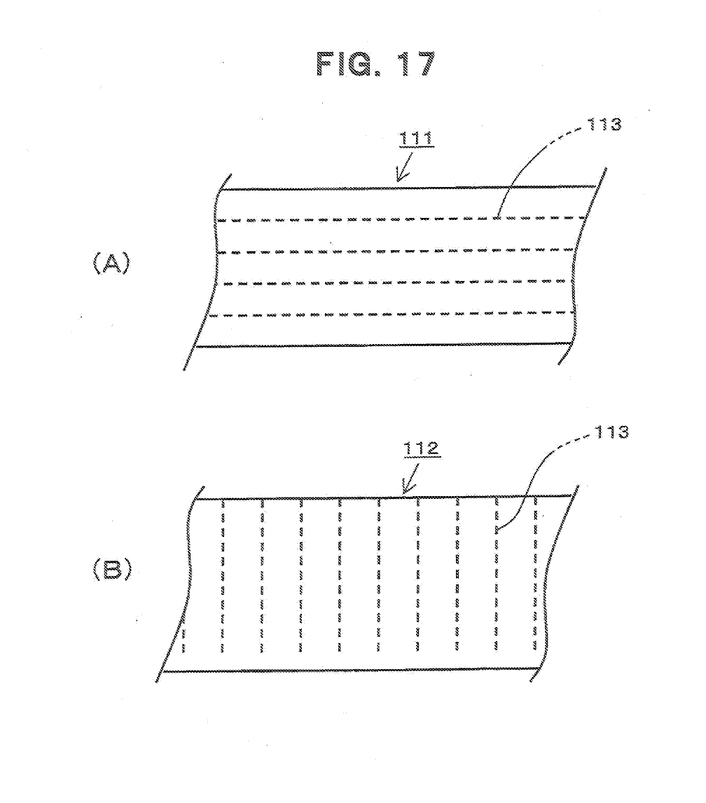

Although the explanation has been carried out based on the case of a unidirectional reinforcing-fiber substrate formed by arranging dry reinforcing-fiber strands in parallel to each other hereinabove, the technology is not limited thereto, a so-called “prepreg,” in which a thermosetting resin such as an epoxy resin or a thermoplastic resin such as a nylon is impregnated into reinforcing-fiber strands, may be employed, and a so-called “semipreg,” in which a resin adheres only to the surfaces of reinforcing-fiber strands, may be employed. In this case, the unidirectional reinforcing-fiber substrate is preferably formed such that a flat reinforcing-fiber sheet is formed wherein reinforcing fibers are continuously arranged in a direction across the fibers by a binding force of a resin, and cut lines are provided to the sheet in a direction parallel to the fibers to form respective reinforcing-fiber strands. Concretely, as shown in FIG. 17(A), it is preferred to use a substrate wherein continuous cut lines 113 shown by dot lines are provided to a reinforcing-fiber sheet 111, arranged with reinforcing fibers in a direction parallel to the longitudinal direction of the strip shape, in parallel to the reinforcing fibers, or as shown in FIG. 17(B), it is preferred to use a substrate wherein continuous cut lines 113 shown by dot lines are provided to a reinforcing-fiber sheet 112, arranged with reinforcing fibers in a direction perpendicular to the longitudinal direction of the strip shape, in parallel to the reinforcing fibers. By the presence of cut lines 113, reinforcing fibers are divided into respective strands, similarly to the case explained so far using a unidirectional reinforcing-fiber substrate formed by dry reinforcing-fiber strands, the respective strand units can move individually when the substrate is deformed into a curved shape, and therefore, a desired arrangement configuration of reinforcing-fiber strands for a curved substrate can be achieved.

Further, similarly, also with respect to a reinforcing-fiber layered structure and a preform formed therefrom along a mold, the original material is not limited to a dry reinforcing-fiber substrate and, even if a prepreg or a semipreg is used, the technical advantages can be exhibited.

### INDUSTRIAL APPLICATIONS

We provide for molding of a large-scaled, long-sized curved fiber-reinforced resin composite material, forming of a preform served to the molding, a reinforcing-fiber layered structure served to the forming of the preform, and a reinforcing-fiber substrate served to the preparation of the layered structure and, for example, suitable to be applied to molding of a reinforcing member of a circular body of an airplane.

### EXPLANATION OF SYMBOLS

1: reinforcing-fiber strand
2: unidirectional reinforcing-fiber substrate
3: auxiliary yarn
11: apparatus for producing a reinforcing-fiber strip substrate
12: flexible member
12a: contact surface
13a, 13b: straightening means
14a, 14b: circular-arc shape achieving means
15: support plate
15a: contact surface of support plate
21: small piece
31, 31a, 35, 35a: reinforcing-fiber strand
32, 32a, 32b, 37a, 37b, 37c: unidirectional reinforcing-fiber substrate
33, 36: auxiliary yarn
34, 38: cut line
41, 41a, 41b: flexible member
42, 45, 52, 56: small piece
43, 46, 51, 57: metal plate spring
44a, 44b, 44c, 50a, 50b, 55: flexible member
58a: recessed portion
58b: projected portion
59: small piece pitch regulating means
60: reinforcing-fiber layered structure
61, 71, 81: preform
62a, 62b, 72a, 72b, 82a, 82b: flange portion
63, 73, 84: web portion
82a′: divided flange portion
83: space
91, 101: preform
92: mold
93: bag material
102: lower mold
103: upper mold
104: mold formed as a double-sided mold
111, 112: reinforcing-fiber sheet
113: cut line

1. A process of producing a reinforcing-fiber strip substrate having a circular-arc part comprising:
contacting one surface of a strip-shaped, unidirectional reinforcing-fiber substrate formed by arranging a plurality of reinforcing-fiber strands in one direction in parallel with each other with a flexible member;
deforming said unidirectional reinforcing-fiber substrate into a circular-arc shape by deforming at least a part of said flexible member into a circular-arc shape in a direction extending along its contact surface with said unidirectional reinforcing-fiber substrate, wherein, using a unidirectional reinforcing-fiber substrate arranged with said reinforcing-fiber strands at an angle of 30 degrees or more and 90 degrees or less relative to a longitudinal direction of said substrate, when said flexible member is deformed into said circular-arc shape, an interval between said reinforcing-fiber strands adjacent to each other is changed at least at one position in a longitudinal direction of said reinforcing-fiber strands by contracting an inner-radius side of said circular-arc shape in a circumferential direction and/or expanding an outer-radius side of said circular-arc shape in a circumferential direction; and thereafter,
separating said flexible member from said unidirectional reinforcing-fiber substrate having been deformed.

2. The process according to claim 1, wherein, using a unidirectional reinforcing-fiber substrate formed by connecting said reinforcing-fiber strands to each other by auxiliary yarns extending in a direction across said reinforcing-fiber strands in which a gap between said reinforcing-fiber strands satisfies the following equation, when said flexible member is deformed into said circular-arc shape, said interval between said reinforcing-fiber strands is contracted by contracting an inner-radius side of said circular-arc shape in a circumferential direction:
d/W1≧W2/r1
wherein:
W1: Width of reinforcing-fiber strand
d: Gap between reinforcing-fiber strands
r1: Inner radius of circular-arc shape
W2: Width of unidirectional reinforcing-fiber substrate.

3. A reinforcing-fiber layered structure having a circular-arc part comprising a plurality of kinds of reinforcing-fiber strip substrates, each having a circular-arc part, whose directions of reinforcing-fiber strands are different from each other, obtained by the process according to claim 1, and are layered.

4. A preform formed by placing a reinforcing-fiber layered structure according to claim 3 along a stereo-shaped mold having a circular-arc part in a longitudinal direction.

5. A fiber-reinforced resin composite material produced by impregnating a matrix resin into a preform according to claim 4 and curing said matrix resin.

6. An apparatus for producing a reinforcing-fiber strip substrate having a circular-arc part wherein said apparatus is for deforming at least a part of a strip-shaped, unidirectional reinforcing-fiber substrate, formed by arranging a plurality of reinforcing-fiber strands in one direction in parallel with each other, into a circular-arc shape, and said apparatus comprising:
a flexible member having a flat contact surface with said unidirectional reinforcing-fiber substrate in which said contact surface can be bent from a straight state in a longitudinal direction into a circular-arc shape in a direction along said contact surface;
a straightener that straightens said flexible member in said longitudinal direction; and
a circular-arc shaper that forms said flexible member in a state of said circular-arc shape.

7. The apparatus according to claim 6, wherein said flexible member comprises a plurality of elongated small pieces capable of being varied with mutual positions which are disposed adjacent to each other.

8. The apparatus according to claim 7, wherein said contact surface of said flexible member is formed by arranging a plurality of elongated small pieces extending in a direction across a longitudinal direction of said contact surface in parallel with each other along said longitudinal direction of said contact surface, longitudinal directions of respective small pieces are set at angles of 30 degrees or more and 90 degrees or less relative to said longitudinal direction of said contact surface, and respective small pieces are provided so as to be able to be rotated relative to each other or so as to be able to be rotated relative to each other and moved relative to each other in said longitudinal directions of small pieces.

9. The apparatus according to claim 8, wherein said flexible member comprises a deformable member capable of being recovered to a straightened shape from a shape bent into a circular-arc shape, and said small pieces connected thereto.

10. The apparatus according to claim 9, wherein said small pieces are connected to said deformable member at a condition with a constant positional relationship.

11. The apparatus according to claim 9, wherein said small pieces are connected to said deformable member at a condition free to rotate.

12. The apparatus according to claim 8, wherein a small piece pitch regulator is provided to regulate a pitch between adjacent small pieces to a predetermined value at an appropriate position in a longitudinal direction of small piece at a state where said flexible member is bent into a circular-arc shape.

13. The apparatus according to claim 7, wherein said contact surface of said flexible member is formed by arranging a plurality of elongated small pieces extending in a direction along a longitudinal direction of said contact surface in parallel with each other along a direction across said longitudinal direction of said contact surface, and respective small pieces are constituted to be able to be deformed into a circular-arc shape in a direction along said contact surface and are provided so that small pieces adjacent to each other can mutually move in their longitudinal directions at a condition of parallel displacement when deformed into said circular-arc shape.

14. The apparatus according to claim 6, wherein a support plate is provided which is disposed at a side of said unidirectional reinforcing-fiber substrate, opposite to a side disposed with said flexible member, and which has a flat contact surface capable of being brought into contact with said unidirectional reinforcing-fiber substrate always during a time when said flat contact surface of said flexible member is deformed from said straight state in said longitudinal direction to a state of said circular-arc shape formed by being bent.

15. The apparatus according to claim 14, wherein said support plate comprises an electrostatic attractor plate that attracts an object material by static electricity.

16. The apparatus according to claim 14, wherein said support plate is provided movably in directions for approaching to and retreating from said contact surface of said flexible member in a direction perpendicular to said contact surface, and movably in a direction parallel to said contact surface.
